(19) United States
(12) Patent Application Publication
(10) Pub. No.: US 2014/0317090 A1
(43) Pub. Date: Oct. 23, 2014

(54) TECHNIQUES FOR PREVIEWING GRAPHICAL SEARCH RESULTS

(71) Applicants: Dimitri Negroponte, Los Angeles, CA (US); Matthew M. Mackey, Glendale, CA (US)

(72) Inventors: Dimitri Negroponte, Los Angeles, CA (US); Matthew M. Mackey, Glendale, CA (US)

(21) Appl. No.: 13/977,143

(22) PCT Filed: Dec. 22, 2011
(86) PCT No.: PCT/US11/66913

§ 371 Date: Apr. 18, 2014

Related U.S. Application Data
(60) Provisional application No. 61/524,872, filed on Aug. 18, 2011.

(51) Int. Cl. G06F 17/30

(52) U.S. Cl. CPC G06F 17/30554
USPC 707/722

(57) ABSTRACT

Techniques to preview graphical search results may include determining that information is inside a search field. Search results may be determined based on the information. A set of the search results may be presented as a set of graphical images. The set of graphical images may include a foremost graphical image that is fully visible and one or more rearward graphical images that are shifted so that a portion of a rearward graphical image is visible on a display. Other embodiments are described and claimed.

### PRIORITY INFORMATION

This application claims priority to the commonly-owned co-pending provisional patent application U.S. Ser. No. 61/524,872, entitled “Graphical Search Results Previewer for a Portable Electronic Device”, filed Aug. 18, 2011.

### BACKGROUND

Currently, in response to a keyword-based query, a search engine typically presents a user with a results summary containing a set of ordered uniform resource locators (URLs) determined to be relevant to the query. Each URL is typically accompanied by an abbreviated text preview extracted from within the content accessible at the URL.

However, using web search engines can be a frustrating experience. Web search engines may be particularly difficult to use on portable electronic devices, such as smart phones and mobile devices, due to the typically small displays of portable electronic devices and difficult to read URLs. Additionally, in many instances it may not be readily apparent from the extracted text which URL or URLs will best provide the information the user seeks. As a result, the user is forced to explore the results in an iterative fashion by opening up each website associated with the URL in order to determine its relevance to the user's search.

Despite recent improvements in wireless bandwidth, repeatedly loading candidate URLs and returning to the results summary remains a cumbersome process. To speed this process, some search engines fetch and present thumbnail-sized graphical previews of each website that the user can view by placing a mouse over a corresponding entry within the results summary. However, this solution is not well adapted for use on the typically small displays of portable electronic devices as the thumbnail images are too small to provide a meaningful preview of the web site. It is with respect to these and other considerations that the present improvements have been needed.

### BRIEF DESCRIPTION OF THE DRAWINGS

FIG. 1 illustrates an embodiment of a system to preview graphical search results.

FIG. 2 illustrates an embodiment of a logic flow for the system of FIG. 1.

FIG. 3 discloses an embodiment of the graphical image search results.

FIG. 4 illustrates an embodiment of a centralized system for the system of FIG. 1.

FIG. 5 illustrates one embodiment of cycling through the graphical images.

FIG. 6 illustrates one embodiment of an expanding a graphical image.

FIG. 7 illustrates one embodiment of a logic flow for removing the foremost graphical image.

FIG. 8 illustrates an embodiment of a computing architecture.

FIG. 9 illustrates an embodiment of a communications architecture.

### DETAILED DESCRIPTION

Various embodiments are directed to techniques for previewing graphical search results. In an embodiment, it may be determined that information is inside a search field. Search results may be determined based on the information. A set of the search results may be presented as graphical images. A foremost graphical image may be fully visible on a screen and rearward graphical images may be shifted so that a portion of a rearward graphical image is visible on a display. As a result, a user can quickly and easily determine whether the search result is relevant without having to spend the time individually opening and loading each result on a display screen. By displaying the graphical image for each search result rather than just a name and/or URL, it is much more obvious to a user as to whether the search result is relevant to the search information. The embodiments can improve affordability, scalability, modularity, extendibility, or interoperability for an operator, device or network.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter.

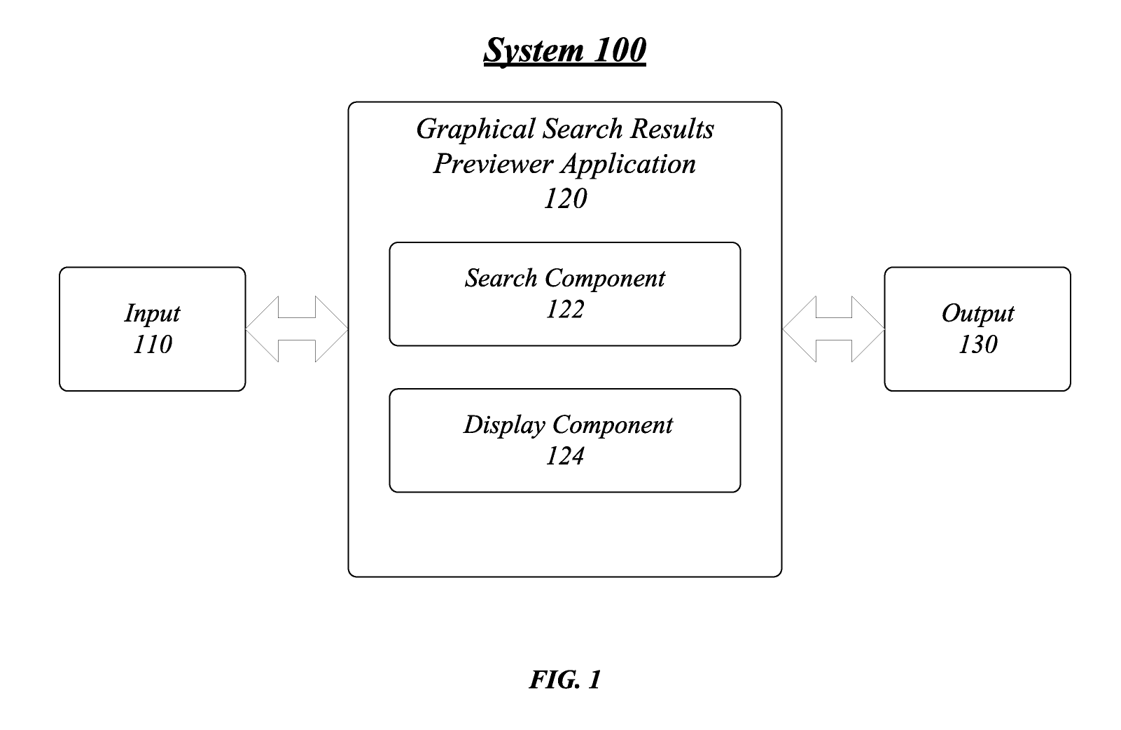

FIG. 1 illustrates a block diagram for a system 100 to preview graphical search results. In one embodiment, the system 100 may comprise a computer-implemented system 100 having one or more software applications and/or components. Although the system 100 shown in FIG. 1 has a limited number of elements in a certain topology, it may be appreciated that the system 100 may include more or less elements in alternate topologies as desired for a given implementation.

The system 100 may comprise a graphical search results previewer application 120. In an embodiment, a graphical search results previewer application 120 may include a search component 122 and a display component 124. A search component 122 may receive input 110. In an embodiment, a search component 122 may determine that information is inside a search field. The information may be an input 110 for the graphical search results previewer application 120. In an embodiment, the search component 122 may determine search results based on the information. In an embodiment, a display component 124 may present a set of the search results as graphical images. The graphical images may be an output 130 for the graphical search results previewer application 120. In an embodiment, a graphical image may be a graphical preview of a document. A document may be a website, webpage, picture, text and/or portable document format (PDF), etc.

In an embodiment, a display component 124 may present a set of graphical images. The set of graphical images may include a foremost graphical image which is fully visible on a display and one or more rearward graphical images that are shifted so that a portion of a rearward graphical image is visible on the display. In an embodiment, the set of graphical images may appear stacked with the foremost being fully visible and only a top portion of a rearward graphical image may be visible. In an embodiment, a top portion of each rearward graphical image may be visible on the display.

In an embodiment, the display component 124 may present a set of graphical images in various formats such as, but not limited to, a matrix. In an embodiment, a foremost graphical image and a rearward graphical image from a set may be presented as the forward graphical image next to the rearward graphical image.

The display component 124 may cycle through the set of graphical images from the foremost graphical image to a rearmost graphical image on the display. In an embodiment, the display component 124 may cycle through the set of graphical images so that the foremost graphical image becomes a rearward graphical image and one of the rearward graphical images becomes a foremost graphical image on the display based on an input. In an embodiment, an input 110 may be a received gesture. The input 110 may be determined by a touch-sensitive input device, such as, but not limited to, a touch screen, a keyboard, and/or a trackball. The embodiments, however, are not limited to these examples.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

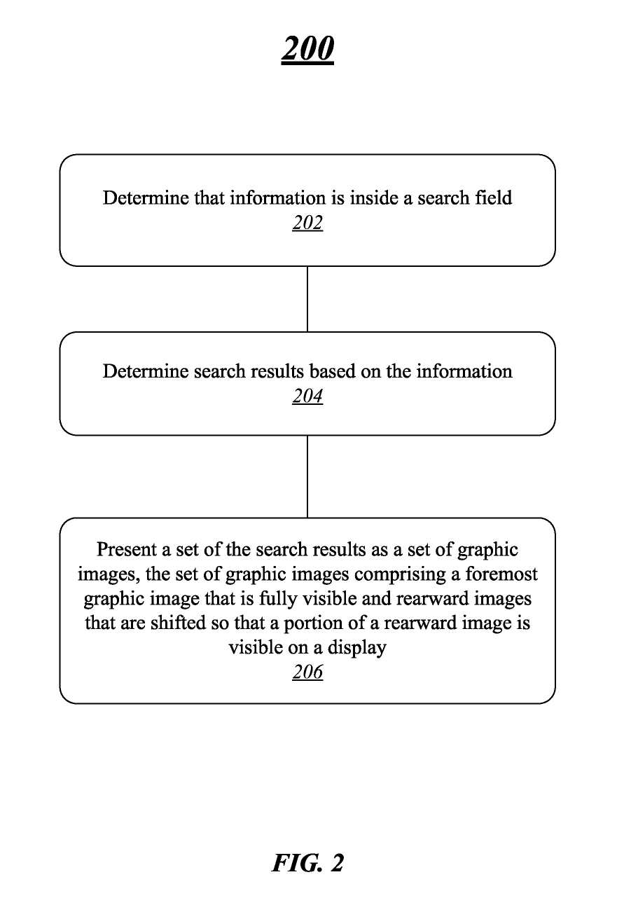

FIG. 2 illustrates one embodiment of a logic flow 200. The logic flow 200 may be representative of some or all of the operations executed by one or more embodiments described herein.

In the illustrated embodiment shown in FIG. 2, the logic flow 200 may determine that information is inside a search field at block 202. In an embodiment, information may be positioned inside a search field. For example, information inside a search field may be a text-based query string. In an embodiment, a search field may be part of a search entry form. In an embodiment, a text-based query string may be a word such as “apple” on a search page. A search page may include search pages or a search screen such as, but not limited to, Yahoo.com®, Ask.com®, or Google.com®.

In an embodiment, a search field may be a part of a search page on a website. For example, a text-based query string may be a word such as “speaker” on a search page such as a website for a store such as, but not limited to, Best Buy® or Amazon.com®.

The logic flow 200 may determine search results based on the information at block 204. In an embodiment, the search component may pass the information to a back-end search engine and retrieve a plurality of search results. Back-end search engines may include search engines from software companies such as, but not limited to, Google®, Alta Vista® and Excite®. In an embodiment, search engines may fetch as many documents as possible that include the text-based query string. The search engine may use the index which may have previously searched, scanned and/or read the documents. In an embodiment, the index may reflect the number of times the text-based query string is located inside a document. The search engine may have used an algorithm to create the index. In an embodiment, the search results or a set of the search results may be presented on a display of the mobile device.

In an embodiment, the search component may wirelessly send a query to a remote device. In an embodiment, the remote device may include a back-end search engine. In an embodiment, the query may be based on the information inside the search field. In an embodiment, the search results may be wirelessly received from the remote device. In an embodiment, the search results or a set of the search results may be presented on a display of the mobile device.

In an embodiment, the search results may be a set, list or grouping of documents. In an embodiment, a search component may retrieve a set of M search results. In an embodiment, the M search results may be determined based on the information. In an embodiment, M may be an integer. In an embodiment, the M search results may be ordered by the search engine from the most relevant document to the least relevant document. In an embodiment, the results may be ordered from most relevant to least relevant as determined by the search computations or search algorithm from the search engine.

In an embodiment, a first N search results may be selected from the M search results. In an embodiment, the first N search results may be the set of graphical images on the display. In an embodiment, N may be an integer. N may be less than or equal to M. In an embodiment, N may be determined by a user. In an embodiment, N may be chosen based on M. In an embodiment, N may be chosen by the search engine. For example, twenty search results may be determined based on the information. As a result, M may be twenty. A set of the twenty search results to be presented on the display may be determined. In an embodiment, N may be less than or equal to M, so N may be less than or equal to twenty. In an embodiment, a set of five search results may be presented on the display from the twenty search results. As a result, N may be five. In an embodiment, N may be the five first, or the five most relevant, search results of the twenty search results. The embodiments are not limited to this example.

The logic flow 200 may present a set of the search results as a set of graphical images at block 206. The set of graphical images may include a foremost graphical image that is fully visible and rearward graphical images that are shifted so that a portion of a rearward graphical image is visible on a display. For example, a set of search results may be presented as a stack of graphical previews. In an embodiment, a graphical image may be a nearly full screen graphical preview of the most relevant search result in a set of search results. In an embodiment, the most relevant search result may be the first or foremost search result in a stack or set of search results. In an embodiment, the first search result in a stack may be the most relevant search result in a stack based on the search engine.

In an embodiment, the stack may be a perspective stack in which the foremost graphical image is fully visible. In an embodiment, there may be one or more rearward graphical images. In an embodiment, there may be a plurality of rearward graphical images. In an embodiment, a rearward graphical image may be shifted so that a portion of the rearward graphical image is visible so as to present the graphical images in a perspective stack on the display. In an embodiment, a top portion of each rearward graphical image may be presented on the display. In an embodiment, the top portion presented on a rearward graphical image may be a title. In an embodiment, the title may be the extracted the contents of the HTML <title> tag. In an embodiment, the title maybe displayed within the visible portion of a rearward graphical image. In an embodiment, the title may present a name of the website and/or a uniform resource locator.

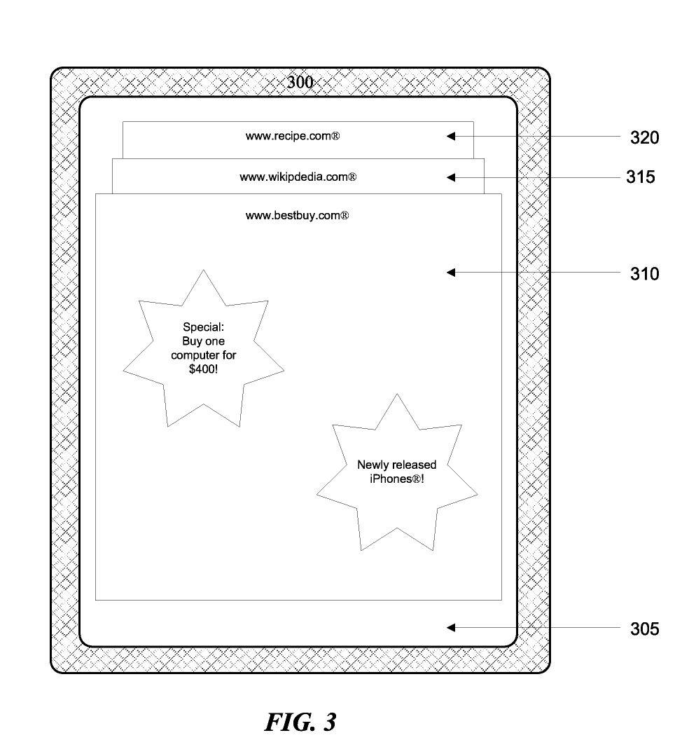

FIG. 3 discloses an embodiment of the graphical image search results. In an embodiment, the search results may include a set of three graphical images 310, 315 and 320 on the display 305 of a mobile device 300. In an embodiment, a first graphical image 310 may be a foremost graphical image. In an embodiment, the first graphical image 310 may be fully visible. For example, no other graphical image may be on top of or cover the foremost graphical image 310. As no other graphical images are covering the first graphical image, the first graphical image may be presented on the display in its entirety or whole. In an embodiment, the first graphical image 310 may span at least a substantial length of the display 305. In an embodiment, the first graphical image 310 may cover approximately ¾ of the length of the display. In an embodiment, the first graphical image 310 may span at least a substantial width of the display 305. In an embodiment, the first graphical image 310 may span the entire width of the display 305. As a result, a user can quickly and easily determine whether the URL is relevant without having to spend the time opening additional windows on a display.

In an embodiment, the first graphical image 310 may be presented as a front graphical image in a stack of graphical images. In an embodiment, the top or title portion of the first graphical image 310 may include the URL www.Bestbuy.com®.

In an embodiment, a second graphical image 315 may be a rearward graphical image and may be presented behind the first graphical image 310. In an embodiment, the display component 124 may present the second graphical image 315 in a receding manner from the first graphical image 310. However, a portion of the second graphical image 315 may be presented on the display 305. In an embodiment, a top portion of the second graphical image 315 may be presented on the display 305. In an embodiment, a top portion of the second graphical image 315 may include a title. In an embodiment, the contents of the hypertext markup language (HTML) title tag of a URL and/or the name of a website may be positioned atop the second graphical image 315. For example, on the second graphical image, the title portion of the second graphical image 315 may include the URL www.Wikipedia.com®.

In an embodiment, a third graphical image 320 may be presented behind the second graphical image 315. In an embodiment, a third graphical image 320 may be presented in a receding manner behind the second graphical image 315 and the second graphical image 315 may be presented in a receding manner behind the first graphical image. 310. However, a portion of the third graphical image 320 may be presented on the display 305. In an embodiment, a top portion of the third graphical image 320 may be presented on the display 305. In an embodiment, the contents of the HTML title tag of a URL atop the third graphical image 320 may be presented on the display 305. In an embodiment, the top portion of the third graphical image 320 may include a title such as, but not limited to, the URL www.Recipe.com®.

In an embodiment, the widths of successive graphical images may decrease. For example, a third graphical image 320 may have a smaller width than the second graphical image 315 and the second graphical image 315 may have a smaller width than a first graphical image 310. The embodiments are not limited to this example.

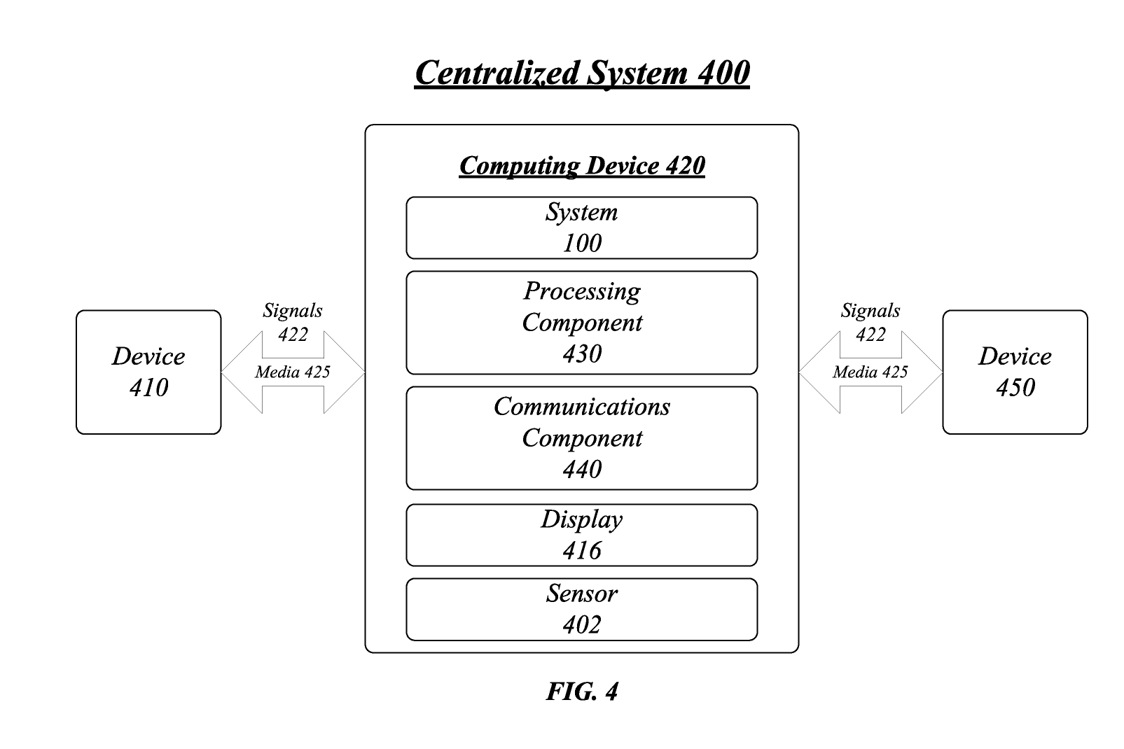

FIG. 4 illustrates a block diagram of a centralized system 400. The centralized system 400 may implement some or all of the structure and/or operations for the system 100 in a single computing entity, such as entirely within a single computing device 420.

In an embodiment, a computing device 420 may be include, but is not limited to, a computer, server, workstation, desktop computer, a laptop computer, a tablet, a mobile device, notebook computer, handheld computer, telephone, cellular telephone, personal digital assistant (PDA), combination cellular telephone and PDA, and so forth.

The computing device 420 may execute processing operations or logic for the system 100 using a processing component 430. The processing component 430 may comprise various hardware elements, software elements, or a combination of both. Examples of hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The computing device 420 may execute communications operations or logic for the system 100 using a communications component 440. The communications component 440 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 440 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 420 includes wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media 425.

The computing device 420 may communicate with other devices 410, 450 over a communications media 425 using communications signals 422 via the communications component 440.

In various embodiments, a computing device 420 may include a display 416. The display 416 may comprise a cathode ray tube (CRTs), liquid crystal displays (LCDs), light emitting diode displays (LEDs), organic light emitting diode displays (OLEDs) or any other type of display. In some embodiments, the display 416 may comprise a touch-sensitive or multi-touch-sensitive display operative to detect the presence and location of a touch within the display area. For example, the touch may generally refer to touch or contact to the display of the device by a finger, hand or other object such as a stylus.

In various embodiments, computing device 420 may include a sensor 402. In an embodiment, the sensor 402 may be separate from the display 416. In an embodiment, a sensor 402 may be configured on the front, back or on a side of the computing device 420. In an embodiment, the sensor 402 may be a contoured sensor. In an embodiment, a sensor 102 may comprise an input device having a touch-sensitive surface operative to detect movement input. For example, in some embodiments, the touch-sensitive surface may comprise one or more capacitive sensors, one or more optical sensors, or a combination of capacitive and optical sensors. The touch-sensitive surface of sensor 402 may be selected such that it is capable of detecting small movements, such as the sliding or rolling of a human thumb that remains in contact with the sensor 402.

In an embodiment, the sensor 402 may be operative to output a signal to control one or more components of the computing device 420 or a cursor on display 416 of the computing device 400, in some embodiments. In an embodiment, the output from the sensor 403 may be used by the display component 124. For example, movement information that is detected or sensed by sensor 402 may be interpreted as changes in a coordinate on a display 416. In various embodiments, for example, up and down movement in a direction from top to bottom or from bottom to top on sensor 402 may be interpreted as up and down movement of a cursor or as an up and down scrolling movement. Similarly, movement in a direction from front to back or from back to front may be interpreted as left to right movement of a cursor on the display 416. Based on the movement in a direction detected by the sensor 402, the display component 124 may display the set of graphical images cycling from front to back or forward to backward. In an embodiment, the images may cycle from back to front or backward to forward. In an embodiment, based on the movement in a direction detected by the sensor 402, the display component may expand the foremost graphical to the full size of the display 416. In an embodiment, based on the movement in a direction detected by the sensor 402, the display component may initiate a new search. It should be understood that the uses and functionality of the sensor 402 described herein are provided for purposes of illustration and not limitation. As such, a person of ordinarily skill in the art would appreciate that the contoured sensor 402 described herein could be used for any number of purposes and still fall within the described embodiments. The embodiments are not limited to these examples.

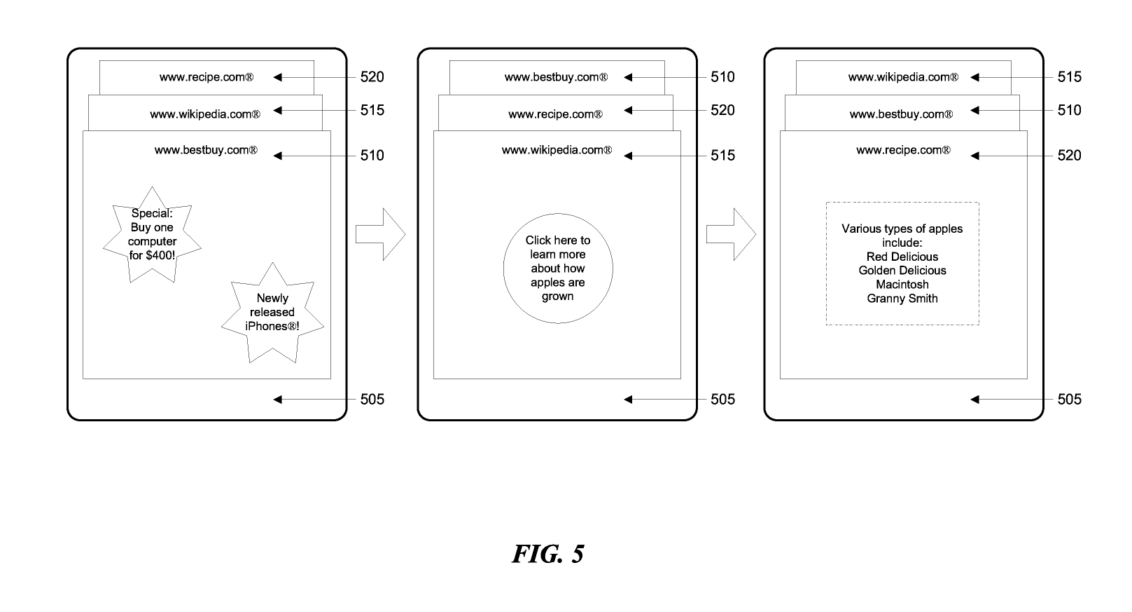

FIG. 5 illustrates one embodiment of cycling through the graphical images. In an embodiment, a user may cycle through the set of graphical images from the foremost graphical image to a rearmost graphical image on the display. In an embodiment, a set of search results may be cycled through. In an embodiment, the set of graphical images may be animated to cycle through each image from the foremost graphical image to a rearmost graphical image as a result of receiving a gesture. In an embodiment, the foremost graphical image and rearward graphical images of the presented search results may be cycled through so that the foremost graphical image may become a rearward graphical image and one of the rearward graphical images may become a foremost graphical image. In an embodiment, the set of graphical images may cycle in either direction. For example, the foremost graphical image may be sent to the rearmost image and/or the rearmost graphical image may become the foremost graphical image. During cycling each graphical image in the set may move either forward or backward, based on the cycling direction, in order to preserve the relative ordering and maintain a constant space between the graphical images within the set.

In an embodiment, a top to bottom movement by a user's digit on a sensor may cause the display component to cycle through the set of graphical images so that each graphical image in the set may move either forward or backward. By using the sensor to cycle through the graphical images, a user may rapidly and continuously view the search results without having to spend the time opening a variety of windows on a display screen.

As shown in FIG. 5, there may be a first graphical image 510, a second graphical image 515 and a third graphical image 520 first presented on a display 505. In a first configuration, the first graphical image 510 may be the foremost graphical image. The second graphical image 515 may be positioned behind the first graphical image 510 on the display 505. The third graphical image 520 may be positioned behind the second graphical image 515 on the display 505.

The user may cycle the images and the position of the images presented on the display 505 may change. The first graphical image 510 may become a rearward graphical image. For example, the first graphical image 510 may become the third graphical image from the front on the display 505. The second graphical image 515 may become the first or foremost graphical image. In this second configuration, the second graphical image 515 may become the front graphical image and the second graphical image 515 may cover at least a portion of, but not all of the first graphical image 510 as the first graphical image 510 may now be the rearmost graphical image. The third graphical image 520 may become the second graphical image in the set on display 505.

The user may again cycle the images and the position of the images presented on the display 505 may again change. In a third configuration, the second graphical image 515 may change from a foremost graphical image to a rearward graphical image. For example, the second graphical image 515 may become the most rearward graphical on the display 505. The first graphical image 510 may become the second graphical image from the front on the display 505. The third graphical image 520 may become the first or foremost graphical image.

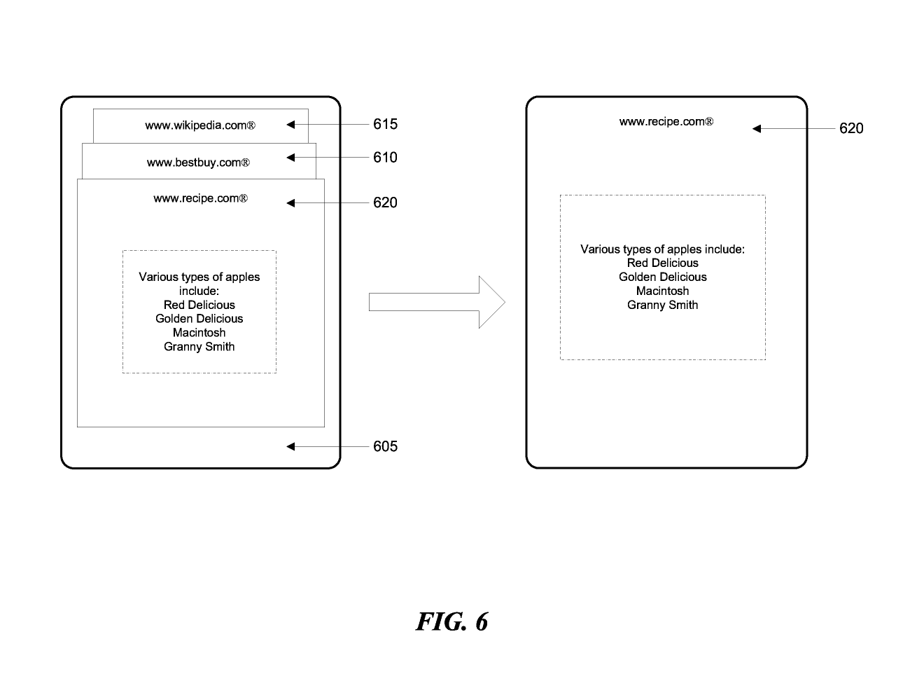

FIG. 6 illustrates one embodiment of an expanding a graphical image. In an embodiment, the foremost graphical image on the display may be expanded to be presented as a full size image. In an embodiment, the third graphical image 620 may be the foremost graphical image. Based on a user input, the foremost graphical image may be presented as a full size image on the display 605. In an embodiment, no portion of the rearward graphical images, 610, 615 may be presented when the foremost graphical image 620 is expanded. In an embodiment, a full featured browser may be invoked and a URL corresponding to the foremost graphical image may be loaded. A user can then interact with the document in a more fully featured manner. For example, a user may zoom, pan and/or enter text into forms.

In an embodiment, the graphical image may be expanded based on an input. In an embodiment, the foremost graphical image 620 may be expanded based on a forward gesture from a user's digit on a sensor. In an embodiment, the foremost graphical image 620 may be expanded based on a leftward flick or rapid movement along the x-axis in a negative direction on the sensor. In an embodiment, the foremost graphical image 620 may be expanded after a period of inactivity. In an embodiment, the foremost graphical image 620 may be expanded after a user has cycled through all the graphical images in the set.

In an embodiment, the expanded graphical image may be contracted. In an embodiment, the graphical image may be contracted based on an input. In an embodiment, the expanded foremost graphical image 620 may be contracted based on a backward gesture from a user's digit on a sensor. For example, the user may perform a rightward flick or rapid movement along the x-axis in a positive direction on the sensor.

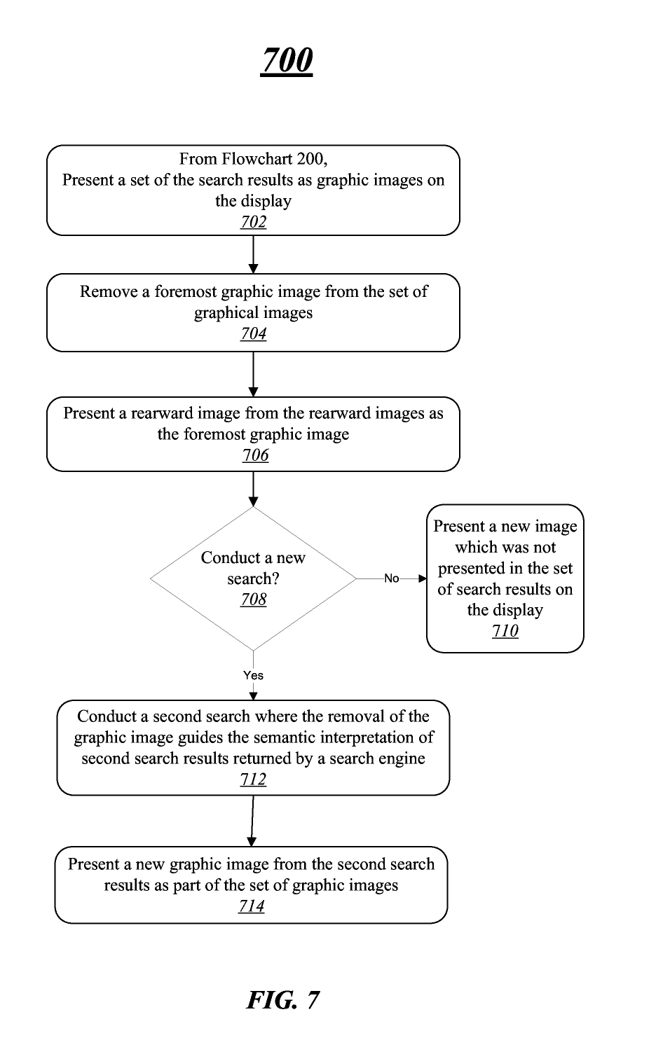

FIG. 7 illustrates one embodiment of a logic flow for removing the foremost graphical image. The logic flow 700 may be representative of some or all of the operations executed by one or more embodiments described herein. In the illustrated embodiment shown in FIG. 7, the logic flow 700 may begin where the logic flow for FIG. 2 ended. The logic flow 700 may present a set of the search results as graphical images on the display at block 702. For example, a user may type the text string “apple” into a search field. The search field may then determine search results based on the information “apple”. For example, five search results may be presented on the display. Each search result may be presented as a graphical image. Each of the five search results may be associated with a URL corresponding to a document such as a webpage or a PDF based on the word “apple”.

The logic flow 700 may remove a foremost graphical image from the set of graphical images at block 704. In an embodiment, a user may view the foremost graphical image in the set and determine that he/she does not like the search result. The user may reject the foremost graphical image and remove that image from the set. For example, the user may not like the first graphical image of the five graphical images resulting from the search of the word “apple”. The first search result may discuss the iPhone®. However, the user may be looking for information about apple trees. As a result, the document or webpage about an iPhone® may not be useful to the user and the user may wish to remove the non-relevant webpage.

In an embodiment, the user may only remove the foremost graphical image when it is an expanded image. In an embodiment, the user may remove the foremost graphical image at any time while viewing the search results. In an embodiment, there may be a symbol or circle on the display representing a button. The user may touch that part of the screen and the foremost graphical image may be removed. In an embodiment, there may be a button on the mobile device. The user may touch that button and the foremost graphical image may be removed. In an embodiment, the user may touch the sensor in a certain way or use a specific gesture to indicate that the foremost graphical image should be removed. The embodiments are not limited to these examples.

The logic flow 700 may present a rearward graphical image from the rearward graphical images as the foremost graphical image at block 706. In an embodiment, the second graphical image may be part of the rearward graphical images. However, once the first graphical image is removed, the second graphical image may become the foremost graphical image. As the foremost graphical image, the previously second graphical image may be presented in its entirety without being blocked.

The logic flow 700 may determine whether to conduct a new search at block 708. In an embodiment, a user may determine whether a new search will be conducted. In an embodiment, a new search may be determined based on the number and/or quality of the remaining (M-N) search results.

In an embodiment, a new graphical image may be presented from the original search results. In an embodiment, a new search may be conducted. If a new search is not conducted, the logic flow 700 may present a new graphical image which was not presented in the set of search results at block 710. The remaining set of images may cycle so that the foremost graphical image was a rearward graphical image. The new graphical may be presented as the rearmost image. In an embodiment, the new graphical may be presented as the foremost graphical image. In an embodiment, the new graphical image may be graphical image N+1 in the originally determined and ordered search results. For example, the original search results may have determined M results. Of the M results that relate to the information that was searched, N results may have originally been presented as the set of search results. As M may be greater than N, there may be results that were not presented on the display as part of the set of search results (N).

The next search result (N+1) in the M search results may be presented as the foremost graphical image. For example, five search results may be presented for the information “apple”. Yet the search for the word “apple” may have received ten search results. However, only the first five results may have been presented as the set of search results. The sixth result in the ten search results may be presented on the display as a graphical image. In an embodiment, the sixth result may be presented as the foremost graphical image.

If a new search is conducted, the logic flow 700 may conduct a second search where the removal of the graphical image guides semantic interpretation of second search results at block 712. In an embodiment, the second search results may be returned by a search engine. In an embodiment, the rejection and/or selection of a graphical image may be used to alter the behavior of the search engine. For example, the selection and removal of the graphical images may be used to guide the semantic interpretation of the search results returned by the search engine. In an embodiment, the selection and removal of the graphical images may be used to guide a semantic interpretation used to order the search results.

In an embodiment, a property of the removed graphical image may be determined. In an embodiment a property may be an aspect, quality or characteristic of the removed graphical image. For example, if the search was for “apple” and a document or webpage for the iPhone® was removed, the property determined may be “computer products”.

In an embodiment, a new or second search may be conducted which includes the information and excludes the property of the removed graphical image. For example, the new search may include the information “apple” and may exclude “computer products” based on the rejected iPhone® document or webpage. The search may be conducted where the removal of the iPhone® document or webpage guides the semantic interpretation of search results returned by a search engine. In an embodiment, embodiment, the search may result in a new list of search results. The new search results may be ordered and ranked by the search engine. In an embodiment, the search engine may determine which of the documents are most relevant and/or most closely correspond with the information “apple” and exclude “computer products”.

In an embodiment, the logic flow 700 may present a new graphical image from the second search results as part of the set of graphical images at block 714. In an embodiment, the search result which is most relevant and/or most closely corresponds to the information and excludes the property may be added to the search results and presented on the display as a graphical image. In an embodiment, the new graphical image may be presented as a rearward image. In an embodiment, the new graphical image may be presented as the rearmost graphical image. In an embodiment, the new graphical may be presented as the foremost graphical image.

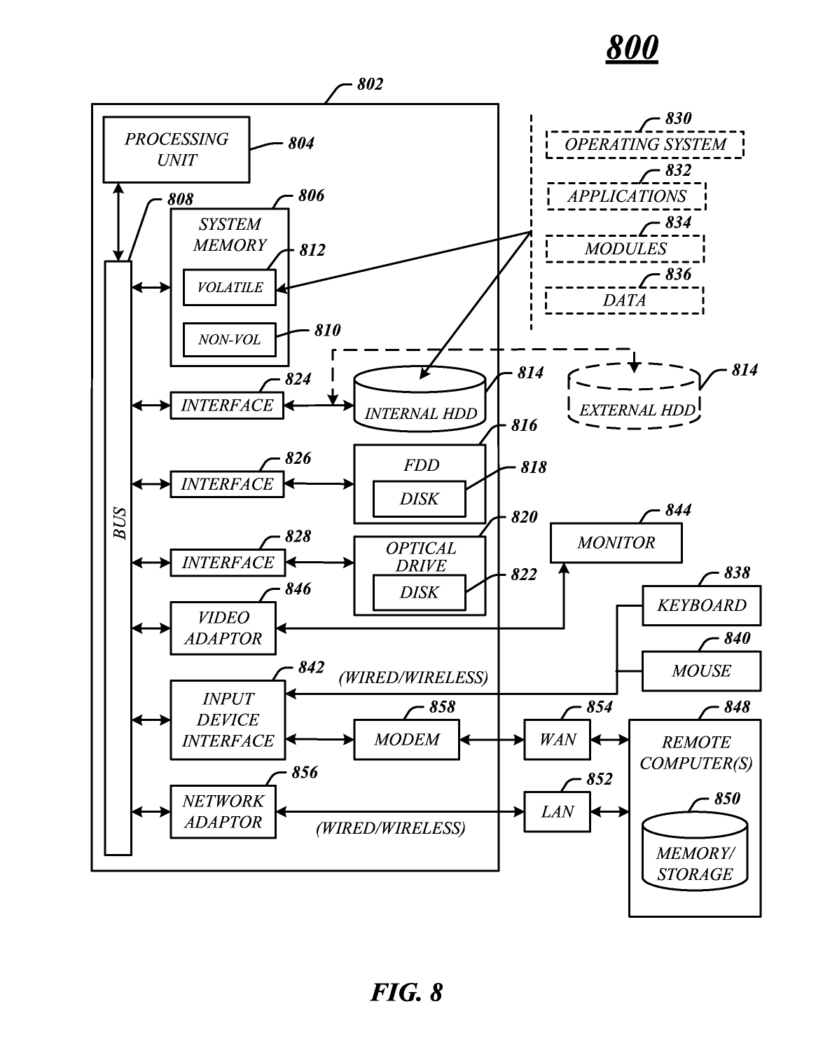

FIG. 8 illustrates an embodiment of an exemplary computing architecture 800 suitable for implementing various embodiments as previously described. As used in this application, the terms “system” and “component” are intended to refer to a computer-related entity, either hardware, a combination of hardware and software, software, or software in execution, examples of which are provided by the exemplary computing architecture 800. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

In one embodiment, the computing architecture 800 may comprise or be implemented as part of an electronic device. Examples of an electronic device may include without limitation a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, television, digital television, set top box, wireless access point, base station, subscriber station, mobile subscriber center, radio network controller, router, hub, gateway, bridge, switch, machine, or combination thereof. The embodiments are not limited in this context.

The computing architecture 800 includes various common computing elements, such as one or more processors, co-processors, memory units, chipsets, controllers, peripherals, interfaces, oscillators, timing devices, video cards, audio cards, multimedia input/output (I/O) components, and so forth. The embodiments, however, are not limited to implementation by the computing architecture 800.

As shown in FIG. 8, the computing architecture 800 comprises a processing unit 804, a system memory 806 and a system bus 808. The processing unit 804 can be any of various commercially available processors. Dual microprocessors and other multi-processor architectures may also be employed as the processing unit 804. The system bus 808 provides an interface for system components including, but not limited to, the system memory 806 to the processing unit 804. The system bus 808 can be any of several types of bus structure that may further interconnect to a memory bus (with or without a memory controller), a peripheral bus, and a local bus using any of a variety of commercially available bus architectures.

The computing architecture 800 may comprise or implement various articles of manufacture. An article of manufacture may comprise a computer-readable storage medium to store logic. Embodiments may also be at least partly implemented as instructions contained in or on a non-transitory computer-readable medium, which may be read and executed by one or more processors to enable performance of the operations described herein. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like.

The system memory 806 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. In the illustrated embodiment shown in FIG. 8, the system memory 806 can include non-volatile memory 810 and/or volatile memory 812. A basic input/output system (BIOS) can be stored in the non-volatile memory 810.

The computer 802 may include various types of computer-readable storage media in the form of one or more lower speed memory units, including an internal hard disk drive (HDD) 814, a magnetic floppy disk drive (FDD) 816 to read from or write to a removable magnetic disk 818, and an optical disk drive 820 to read from or write to a removable optical disk 822 (e.g., a CD-ROM or DVD). The HDD 814, FDD 816 and optical disk drive 820 can be connected to the system bus 808 by a HDD interface 824, an FDD interface 826 and an optical drive interface 828, respectively. The HDD interface 824 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 810, 812, including an operating system 830, one or more application programs 832, other program modules 834, and program data 836.

The one or more application programs 832, other program modules 834, and program data 836 can include, for example, the search component 122 and the display component 124.

A user can enter commands and information into the computer 802 through one or more wire/wireless input devices, for example, a keyboard 838 and a pointing device, such as a mouse 840. Other input devices may include a microphone, an infra-red (IR) remote control, a joystick, a game pad, a stylus pen, touch screen, or the like. These and other input devices are often connected to the processing unit 804 through an input device interface 842 that is coupled to the system bus 808, but can be connected by other interfaces such as a parallel port, IEEE 1394 serial port, a game port, a USB port, an IR interface, and so forth.

A monitor 844 or other type of display device is also connected to the system bus 808 via an interface, such as a video adaptor 846. In addition to the monitor 844, a computer typically includes other peripheral output devices, such as speakers, printers, and so forth.

The computer 802 may operate in a networked environment using logical connections via wire and/or wireless communications to one or more remote computers, such as a remote computer 848. The remote computer 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wire/wireless connectivity to a local area network (LAN) 852 and/or larger networks, for example, a wide area network (WAN) 854. Such LAN and WAN networking environments are commonplace in offices and companies, and facilitate enterprise-wide computer networks, such as intranets, all of which may connect to a global communications network, for example, the Internet.

When used in a LAN networking environment, the computer 802 is connected to the LAN 852 through a wire and/or wireless communication network interface or adaptor 856. The adaptor 856 can facilitate wire and/or wireless communications to the LAN 852, which may also include a wireless access point disposed thereon for communicating with the wireless functionality of the adaptor 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wire and/or wireless device, connects to the system bus 808 via the input device interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with wire and wireless devices or entities using the IEEE 802 family of standards, such as wireless devices operatively disposed in wireless communication (e.g., IEEE 802.11 over-the-air modulation techniques) with, for example, a printer, scanner, desktop and/or portable computer, personal digital assistant (PDA), communications satellite, any piece of equipment or location associated with a wirelessly detectable tag (e.g., a kiosk, news stand, restroom), and telephone. This includes at least Wi-Fi (or Wireless Fidelity), WiMax, and Bluetooth™ wireless technologies. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

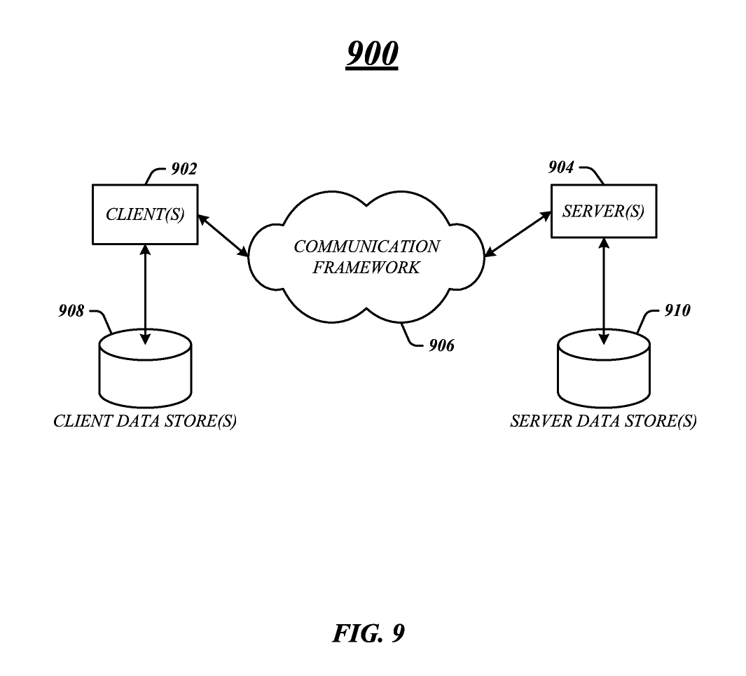

FIG. 9 illustrates a block diagram of an exemplary communications architecture 900 suitable for implementing various embodiments as previously described. The communications architecture 900 includes various common communications elements, such as a transmitter, receiver, transceiver, radio, network interface, baseband processor, antenna, amplifiers, filters, and so forth. The embodiments, however, are not limited to implementation by the communications architecture 900.

As shown in FIG. 9, the communications architecture 900 comprises includes one or more clients 902 and servers 904. The clients 902 may implement the client system 400. The clients 902 and the servers 904 are operatively connected to one or more respective client data stores 908 and server data stores 910 that can be employed to store information local to the respective clients 902 and servers 904, such as cookies and/or associated contextual information.

The clients 902 and the servers 904 may communicate information between each other using a communication framework 906. The communications framework 906 may implement any well-known communications techniques and protocols, such as those described with reference to systems 300 and 800. The communications framework 906 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An article of manufacture comprising a storage medium containing instructions that when executed cause a system to:
determine that information is inside a search field;
determine search results based on the information; and
present a set of the search results as a set of graphical images, the set of graphical images comprising a foremost graphical image that is fully visible and one or more rearward graphical images that are shifted so that a portion of a rearward graphical image is visible on a display.

2. The article of manufacture of claim 1, comprising instructions that when executed cause the system to determine that a text-based query string is inside the search field on a search entry form.

3. The article of manufacture of claim 1, comprising instructions that when executed cause the system to determine a search result from the set of the search results to present as the foremost graphical image.

4. The article of manufacture of claim 1, comprising instructions that when executed cause the system to present a top portion of the rearward graphical image.

5. The article of manufacture of claim 1, comprising instructions that when executed cause the system to expand the foremost graphical image to be presented as a full size image based on a gesture.

6. The article of manufacture of claim 1, comprising instructions that when executed cause the system to present the foremost graphical image with a larger width than the one or more rearward graphical images.

7. The article of manufacture of claim 1, comprising instructions that when executed cause the system to:
determine M search results based on the information;
select a first N search results from the M search results, where N is less than M; and
set the first N search results to be the set of graphical images on the display.

8. The article of manufacture of claim 1, comprising instructions that when executed cause the system to:
receive a gesture from a user's digit on a sensor; and
cycle through the set of graphical images such that the foremost graphical image becomes a rearward graphical image and a rearward graphical image becomes the foremost graphical image based on the received gesture.

9. The article of manufacture of claim 1, comprising instructions that when executed cause the system to:
remove the foremost graphical image from the set of graphical images; and
present a new graphical image which was not presented in the set of graphical images as a rearward graphical image, the new graphical image from the determined search results.

10. The article of manufacture of claim 1, comprising instructions that when executed cause the system to:
remove the foremost graphical image from the set of graphical images;
conduct a second search where the removal of the foremost graphical image guides semantic interpretation of second search results; and
present a new graphical image from the second search results as part of the set of graphical images.

11. A method, comprising:
determining search results based on information inside a search field;
presenting a set of the search results as a set of graphical images, the set of graphical images comprising a foremost graphical image that is fully visible and one or more rearward graphical images that are shifted so that a portion of a rearward graphical image is visible on a display; and
cycling through the set of graphical images from the foremost graphical image to a rearmost image on the display.

12. The method of claim 11, comprising:
cycling through the set of graphical images so that the foremost graphical image becomes a rearward graphical image and a rearward graphical image becomes the foremost graphical image on the display.

13. The method of claim 11, comprising:
determining that a text-based query string is inside the search field on a search entry form.

14. The method of claim 11, comprising:
determining a search result from the set of the search results to present as the foremost graphical image.

15. The method of claim 11, comprising:
wirelessly receiving the search results from a remote device.

16. The method of claim 11, comprising:
wirelessly sending a query to a remote device, the query based on the information inside the search field.

17. The method of claim 11, comprising:
presenting the foremost graphical image with a larger width than the one or more rearward graphical images.

18. The method of claim 11, comprising:
determining M search results based on the information;
selecting a first N search results from the M search results, where N is less than M; and
setting the first N search results to be the set of graphical images on the display.

19. The method of claim 11, comprising:
cycling through the set of graphical images based on a gesture from a user's digit on a sensor.

20. The method of claim 11, comprising:
removing the foremost graphical image from the set of graphical images; and
presenting a new graphical image on the display which was not presented in the set of graphical images as a rearward graphical image, the new graphical image from the determined search results.

21. The method of claim 11, comprising:
removing the foremost graphical image from the set of graphical images;
conducting a second search where the removal of the graphical image guides semantic interpretation of second search results; and
presenting a new graphical image from the second search results as part of the set of graphical images.

22. The method of claim 11, comprising:
expanding the foremost graphical image to be presented as a full size image based on a gesture from a user's digit on a sensor.

23. An apparatus, comprising:
a processing unit;
a search component operative to:
determine that information is inside a search field, and
determine search results based on the information; and
a display component operative to present a set of the search results as graphical images so that a foremost graphical image is fully visible on a screen and one or more rearward graphical images are shifted so that a portion of a rearward graphical image is visible on a display.

24. The apparatus of claim 23, comprising:
an input device comprising a sensor operative to detect a gesture from a user's digit on the sensor; and
the display component operative to expand the foremost graphical image to be presented as a full size image based on the gesture.

25. The apparatus of claim 23, comprising:
an input device comprising a sensor operative to receive a gesture from a user's digit on the sensor; and
the display component operative to cycle through the graphical images such that the foremost graphical image becomes a rearward graphical image and a rearward graphical image becomes the foremost graphical image based on the received gesture.

26. The apparatus of claim 23, comprising:
a digital display operatively coupled to the processing unit.

27. The apparatus of claim 23, the display component operative to place the foremost graphical image next to at least one of the one or more rearward graphical images.

28. The apparatus of claim 23, comprising:
a transceiver operatively coupled to the processing unit.

29. The apparatus of claim 23, comprising:
an antenna operatively coupled to the processing unit.
